(19) United States
(12) Patent Application Publication
(10) Pub. No.: US 2026/0244166 A1
(43) Pub. Date: Aug. 20, 2026

(54) ADAPTIVE POOL CONTROL SYSTEM AND METHOD OF USE

(71) Applicants: Steve Nold, Huntington Beach, CA (US); Tristan de Frondeville, Berkeley, CA (US)

(72) Inventors: Steve Nold, Huntington Beach, CA (US); Tristan de Frondeville, Berkeley, CA (US)

(21) Appl. No.: 19/641,222

(22) Filed: Apr. 7, 2026

Related U.S. Application Data
(60) Provisional application No. 63/785,545, filed on Apr. 8, 2025.

(51) Int. Cl. G05B 13/02; E04H 4/12; G05D 23/19

(52) U.S. Cl. CPC G05B 13/0265; E04H 4/129; G05D 23/1917

(57) ABSTRACT

An adaptive pool control system associated with a pool having a heater and pump, the adaptive pool control system having: a unified control (UC) module configured to communicate with a plurality of data sources and perform predictive control operations based on received environmental and pool usage data; an enhanced pool control system (EPCS) module in communication with the UC module, the EPCS module being configured to perform rule-based and time-scheduled control actions; and an Inter-Speed adaptive pool control and energy management system (IAPCEMS) module in communication with the UC module and the EPCS module, the IAPCEMS module being configured to perform dynamic energy optimization; wherein the adaptive pool control system is configured to calculate a minimum required heating input to maintain a water temperature of the pool at or above a set point temperature and operate the heater and pump in accordance with the calculated minimum required heating.

### CROSS-REFERENCE TO RELATED APPLICATIONS

This application claims the benefit of U.S. Provisional Application No. 63/785,545, filed on Apr. 8, 2025, which is hereby incorporated by reference, to the extent that it is not conflicting with the present application.

### BACKGROUND OF INVENTION

### 1. Field of the Invention:

The invention relates generally to control systems and specifically to temperature and energy management control systems for pools.

### 2. Description of the Related Art

Pool heaters are often utilized in various pool assemblies in order to ensure that suitable water temperature conditions are achieved for a sufficiently comfortable swimming environment. Many different factors may influence the resultant temperature of the pool water, ranging from ambient air temperatures, ground temperatures, solar radiation, weather conditions, etc. While these factors may influence the current and future water temperatures in a pool, current pool temperature control systems are not able to account for these factors and may be configured to only react to the current temperature of the pool water. As a result of this, significant amounts of energy may be expended to heat the pool water, without accounting for environmental and other factors, thus resulting in energy being wasted by overheating the pool beyond the required temperature threshold or heating the pool while not in use. This energy wasted heating the pool beyond the required temperature threshold or while not in use may be significant, thus resulting in significant financial losses, especially during cooler months, and in cooler regions.

Therefore, there is a need to solve the problems described above by providing a device and method for efficiently controlling the water temperature of the pool by reactively and proactively accounting for relevant factors while operating pool heaters and pumps.

The aspects or the problems and the associated solutions presented in this section could be or could have been pursued; they are not necessarily approaches that have been previously conceived or pursued. Therefore, unless otherwise indicated, it should not be assumed that any of the approaches presented in this section qualify as prior art merely by virtue of their presence in this section of the application.

### BRIEF INVENTION SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

In an aspect, an adaptive pool control system associated with a pool having at least one heater and at least one pump is provided, the adaptive pool control system having: a merged pool control system comprising: a unified control (UC) module configured to communicate with one or more of temperature sensors, a weather database, and a pool usage schedule database and to perform predictive control operations based on received environmental and pool usage data; an enhanced pool control system (EPCS) module in data communication with the UC module, the EPCS module being configured to perform rule-based and time-scheduled control actions including heater activation and shutdown based on predetermined pool usage schedules; and an Inter-Speed adaptive pool control and energy management system (IAPCEMS) module in data communication with the UC module and the EPCS module, the IAPCEMS module being configured to perform dynamic energy optimization, including adjusting heater prioritization, and varying pump speed according to predicted thermal load; wherein the adaptive pool control system is configured to receive data from the one or more of temperature sensors, the weather database, and the pool usage schedule database, calculate a minimum required heating input to maintain a pool water temperature of the pool at or above a set point temperature during a defined pool operation window, determine a most efficient heater of the at least one heater and corresponding start and stop times for the most efficient heater, and operate the most efficient heater and the at least one pump in accordance with the calculated minimum required heating to optimize energy efficiency while maintaining desired pool conditions during the defined pool operation window. Thus, an advantage is that the adaptive pool control system may be configured to behave reactively and proactively to various factors in order to provide sufficient heating to the pool without wasting energy. By accounting for potential incoming solar heat gain, based on pool location, current climate/season, historical weather data, etc., the pool control system may be configured to add the minimum amount of heat to the pool to achieve the necessary pool temperature at a given point. Another advantage is that the pool control system may be configured to account for intended operation hours of the pool by optimizing pool heating, such that the pool reaches and maintains the minimum acceptable temperature between the pool opening and pool closing times. In this way, no energy may be wasted by maintaining the pool at a sufficient usage temperature while nobody is intended to be in the pool.

In another aspect, a method of controlling heating and circulation of a pool having at least one heater and at least one pump using an adaptive pool control system, the adaptive pool control system comprising a unified control (UC) module, an enhanced pool control system (EPCS) module in data communication with the UC module, and an Inter-Speed adaptive pool control and energy management system (IAPCEMS) module in data communication with the UC module and the EPCS module is provided, the method comprising: receiving, by the UC module, data from a plurality of data sources, the data comprising one or more of a pool water temperature, outdoor air temperature, heater outlet temperature, pool usage schedules, and forecasted weather data; calculating, by the UC module, a predicted solar heat gain and a total heat loss for the pool over a control period; determining, by the UC module, a minimum heating requirement to maintain the pool water temperature at or above a predefined set point temperature during a defined pool operation window; activating, by the EPCS module, a scheduled heater operation to maintain the pool water temperature at or above the predefined set point temperature during the defined pool operation window; optimizing, by the IAPCEMS module, the scheduled heater operation based on predicted energy cost, usage patterns, and solar gain potential; and controlling, by the IAPCEMS module, a speed of the pump based on real-time temperature inputs and energy efficiency models. Again, an advantage is that the adaptive pool control system may be configured to behave reactively and proactively to various factors in order to provide sufficient heating to the pool without wasting energy. By accounting for potential incoming solar heat gain, based on pool location, current climate/season, historical weather data, etc., the pool control system may be configured to add the minimum amount of heat to the pool to achieve the necessary pool temperature at a given point. Another advantage is that the pool control system may be configured to account for intended operation hours of the pool by optimizing pool heating, such that the pool reaches and maintains the minimum acceptable temperature between the pool opening and pool closing times. In this way, no energy may be wasted by maintaining the pool at a sufficient usage temperature while nobody is intended to be in the pool.

In another aspect, an adaptive pool control system associated with a pool having at least one heater and at least one pump is provided, the adaptive pool control system comprising: a unified control (UC) module configured to communicate with a plurality of data sources and to perform predictive control operations based on received environmental and pool usage data; an enhanced pool control system (EPCS) module in data communication with the UC module, the EPCS module being configured to perform rule-based and time-scheduled control actions including heater activation and shutdown based on predetermined pool usage schedules; and an Inter-Speed adaptive pool control and energy management system (IAPCEMS) module in data communication with the unified control module and the EPCS module, the IAPCEMS module being configured to perform dynamic energy optimization, including adjusting heater prioritization, and varying pump speed according to predicted thermal load; wherein the adaptive pool control system is configured to receive data from the plurality of data sources, calculate a minimum required heating input to maintain a pool water temperature of the pool at or above a set point temperature during a defined pool operation window and operate the heater and pump in accordance with the calculated minimum required heating input to optimize energy efficiency while maintaining desired pool conditions. Again, an advantage is that the adaptive pool control system may be configured to behave reactively and proactively to various factors in order to provide sufficient heating to the pool to maintain desirable conditions while the pool is in use without wasting energy. By accounting for potential incoming solar heat gain, based on pool location, current climate/season, historical weather data, etc., the adaptive pool control system may be configured to add the minimum amount of heat to the pool to achieve the necessary pool temperature at a given point. Another advantage is that the adaptive pool control system may be configured to account for intended operation hours of the pool by optimizing pool heating, such that the pool reaches and maintains the minimum acceptable temperature between the pool opening and pool closing times. In this way, no energy may be wasted by maintaining the pool at a sufficient usage temperature while nobody is intended to be in the pool.

The above aspects or examples and advantages, as well as other aspects or examples and advantages, will become apparent from the ensuing description and accompanying drawings.

### BRIEF DESCRIPTION OF THE DRAWINGS

For exemplification purposes, and not for limitation purposes, aspects, embodiments or examples of the invention are illustrated in the figures of the accompanying drawings, in which:

FIG. 1 illustrates a system-level data and control flow diagram of a first embodiment of the adaptive pool control and energy management system, according to an aspect.

FIG. 2 illustrates a system-level data and control flow diagram of a second embodiment of the adaptive pool control and energy management system, according to an aspect.

FIG. 3 illustrates a system-level data and control flow diagram of a third embodiment of the adaptive pool control and energy management system, according to an aspect.

FIG. 4 illustrates an electrical wiring diagram of the adaptive pool control and energy management system engaging with a preexisting pool system, according to an aspect.

FIG. 5A illustrates a chart showing the evaporation heat loss for a pool running without the adaptive pool control and energy management system for a day in January, according to an aspect.

FIG. 5B illustrates a chart showing the evaporation heat loss for a pool running with the adaptive pool control and energy management system for a day in January, according to an aspect.

FIG. 5C illustrates a summary report table comparing energy consumption for a pool in January with and without the adaptive pool control and energy management system, according to an aspect.

FIG. 5D illustrates a graph comparing hourly evaporation heat loss values for a pool with and without the adaptive pool control system for a day in January, according to an aspect.

FIG. 6A illustrates a chart showing the evaporation heat loss for a pool running without the adaptive pool control and energy management system for a day in July, according to an aspect.

FIG. 6B illustrates a chart showing the evaporation heat loss for a pool running with the adaptive pool control and energy management system for a day in July, according to an aspect.

FIG. 6C illustrates a summary report table comparing energy consumption for a pool in July with and without the adaptive pool control and energy management system, according to an aspect.

FIG. 6D illustrates a graph comparing hourly evaporation heat loss values for a pool with and without the adaptive pool control system for a day in July, according to an aspect.

FIG. 7 illustrates a bar graph comparing average daily energy consumptions for heating a pool with and without the adaptive pool control system in January and July, according to an aspect.

### DETAILED DESCRIPTION

What follows is a description of various aspects, embodiments and/or examples in which the invention may be practiced. Reference will be made to the attached drawings, and the information included in the drawings is part of this detailed description. The aspects, embodiments and/or examples described herein are presented for exemplification purposes, and not for limitation purposes. It should be understood that structural and/or logical modifications could be made by someone of ordinary skills in the art without departing from the scope of the invention. Therefore, the scope of the invention is defined by the accompanying claims and their equivalents.

It should be understood that, for clarity of the drawings and of the specification, some or all details about some structural components or steps that are known in the art are not shown or described if they are not necessary for the invention to be understood by one of ordinary skills in the art.

“Logic” as used herein and throughout this disclosure, refers to any information having the form of instruction signals and/or data that may be applied to direct the operation of a processor. Logic may be formed from signals stored in a device memory. Software is one example of such logic. Logic may also be comprised by digital and/or analog hardware circuits, for example, hardware circuits comprising logical AND, OR, XOR, NAND, NOR, and other logical operations. Logic may be formed from combinations of software and hardware. On a network, logic may be programmed on a server, or a complex of servers. A particular logic unit is not limited to a single logical location on the network.

For the following description, it can be assumed that most correspondingly labeled elements across the figures (e.g., 102 and 202, etc.) possess the same characteristics and are subject to the same structure and function. If there is a difference between correspondingly labeled elements that is not pointed out, and this difference results in a non-corresponding structure or function of an element for a particular embodiment, example or aspect, then the conflicting description given for that particular embodiment, example or aspect shall govern.

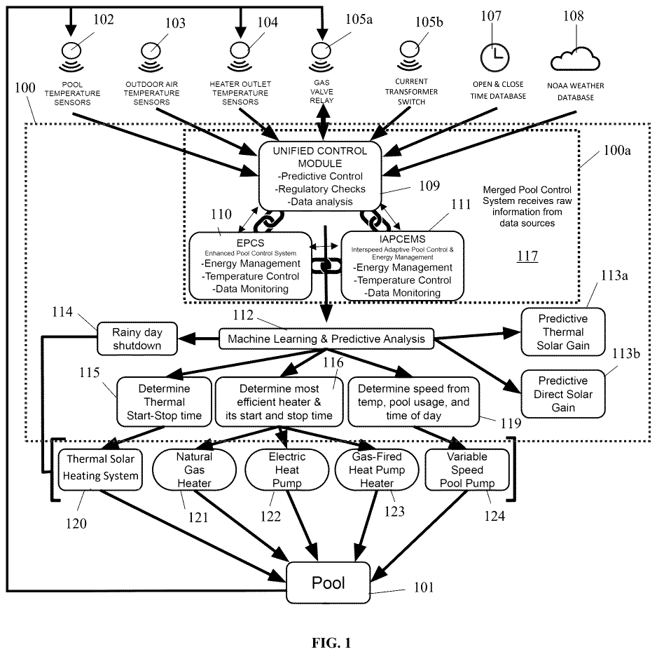

FIG. 1 illustrates a system-level data and control flow diagram of a first embodiment of the adaptive pool control and energy management system 100, according to an aspect. As can be seen in FIG. 1, the adaptive pool control and energy management system (“adaptive pool control system”) 100 may be configured to receive data from various data sources in order to determine the optimal amount of heating to provide to a pool 101 (and the appropriate time to provide said heat) to ensure that the pool temperature remains above a minimum operational set point temperature (“set point temperature”) while in use. In an embodiment, the adaptive pool control system 100 may be configured to be in communication with pool temperature sensors 102, outdoor air temperature sensors 103, heater outlet temperature sensors 104, a gas valve relay 105a, a current transformer switch 105b, an open & close time database 107 and a NOAA weather database 108. It should be understood that the data sources utilized in the adaptive pool control system may not be limited to the ones identified herein, and that the adaptive pool control system 100 may acquire relevant data from other data sources as needed.

In an embodiment, the pool temperature sensors 102 may be configured to be in data communication with the adaptive pool control system 100 and in thermal communication with the water in the pool 101 to allow the adaptive pool control system 100 to collect accurate current pool water temperature readings. In an embodiment, the air temperature sensor 103 may be configured to be in data communication with the adaptive pool control system 100 and thermal communication with the air surrounding the pool 101 (e.g., the ambient environment), to allow the adaptive pool control system 100 to collect accurate outside air (“OSA”)/ambient temperatures. In an embodiment, the heater outlet temperature sensors 104 may be configured to be in thermal communication with the outlet of a pool heater (such as a natural gas heater 121, an electric heat pump heater 122, a gas-fired heat pump heater, or any other suitable pool heater associated with the pool 101) and in data communication with the adaptive pool control system 100 to allow the adaptive pool control system 100 to collect accurate temperatures at the outlet of the corresponding pool heater, while also monitoring heater performance.

In an embodiment, the gas valve relay 105a and the current transformer switch 105b may be in electrical communication with the adaptive pool control system 100. In said embodiment, the gas valve relay 105a and current transformer switch 105b are in electrical communication with adaptive pool control system 100 not only to provide real-time status feedback (from the current transformer switch 105b), but also to receive operational control signals (to the gas valve relay 105a). Unlike the sensors (102, 103, 104), which only passively supply data, the gas valve relay 105a and current transformer switch 105b together enable the adaptive pool control system 100 to actively manage the gas valve's operation based on analysis performed by the adaptive pool control system 100. In an embodiment, the current transformer switch 105b may be configured to provide the adaptive pool control system 100 with the current status of the NG heater (or other applicable heater of the associated pool). In an embodiment, the current transformer switch 105b may be in electrical communication with the adaptive pool control system 100 to provide feedback indicating whether electrical current is present at the gas valve, effectively confirming whether the valve is powered and operating as expected. In an embodiment, unlike the gas valve relay 105a, the current transformer switch 105b does not receive control signals but serves as a monitoring point for operational verification.

In an embodiment, the open & close time database 107 may be in data communication with the adaptive pool control system 100, such that the open and close times for the corresponding associated pool may be factored into determining how much heat to provide to a pool and when to provide heating to the pool to provide optimized pool heating, as will be described in greater detail hereinbelow. Similarly, in an embodiment, the NOAA weather database 108 may be in data communication with the adaptive pool control system 100, such that the current (and historic) weather data may be provided to the adaptive pool control system 100 for use in determining how much heating to provide to a pool and when to provide heating to the pool based upon generated future weather predictions, as will be described in greater detail herein below. It should be understood that the adaptive pool control system 100 may be configured for communication with the herein described sensors, the relay switch and the databases to facilitate the collection of relevant information to determine how much heating to provide to the pool and when to provide it, in order to avoid wasting energy heating the pool when not in use or overheating the pool beyond the required temperature threshold (e.g., above the temperature set point). In an embodiment, the pool temperature sensors 102, outdoor air temperature sensors 103, heater outlet temperature sensors 104, a gas valve relay 105a, a current transformer relay 105b, an open & close time database 107 and a NOAA weather database 108 may be collectively described as “data sources”. In an alternative embodiment, an additional data source may include a pyranometer (not shown) in data communication with the adaptive pool control system 100, wherein the pyranometer is configured to provide real-time solar irradiance measurements to the adaptive pool control system 100.

As seen in FIG. 1, the adaptive pool control system may comprise a unified control module (“UCM”, “UC module”) 109, an enhanced pool control system (“EPCS”) module 110 and an inter-speed adaptive pool control & Energy management system (“IAPCEMS”) module 111, wherein the UCM 109, the EPCS module 110 and the IAPCEMS module 111 are in data communication with each other. In an embodiment, the combination of the UCM 109, the EPCS Module 110, and the IAPCEMS Module 111 may collectively be referred to as a merged pool control system 100a. It should be understood that the UCM, the EPCS module 110 and the IAPCEMS module 111 are distinct modules within the adaptive pool control system architecture, each serving separate but complementary functions. In an embodiment, the unified control module 109, the EPCS module 110 and the IAPCEMS module 111 are in data communication with one another and each module contributes specific capabilities to the overall operation of the adaptive pool control system, including energy management, temperature regulation, and predictive analytics, which will be described in greater detail hereinbelow.

In an embodiment, the unified control module 109 may be configured to function as a central data processor, receiving inputs from all relevant sensors, databases and other data sources and performing data analysis, and generating machine learning predictions and regulatory checks on the incoming inputs. As shown in FIG. 1, the unified control module 109 of the merged pool control system 100a may be configured to be in communication with the pool temperature sensors 102, outdoor air temperature sensors 103, heater outlet temperature sensors 104, the gas valve relay 105a, the current transformer switch 105b, the open & close time database 107 and the NOAA weather database 108 to allow the adaptive pool control system 100 to intake the required information needed for assessing how to manipulate the pool elements (heater(s), pump(s)) based on current conditions, including when heating is required, and if so, how much heating is required.. As described above, the EPCS module 110 and the IAPCEMS module 111 may be in data communication with each other and the unified control module 109, and be configured to facilitate energy management, temperature control, and data monitoring. In an embodiment, the EPCS module 110 may be configured to actuate/manage heating sources based on the predicted needs and solar gain of the pool, wherein the EPCS module 110 is configured to communicate directly with the heaters and thermal solar heating systems. In an embodiment, the IAPCEMS Module 111 may be configured to oversee energy optimization, dynamically select the utilized heating modality (Natural Gas (NG) heating, electric heating, solar heating, etc.), and manage pump speed and heater on/off timings. In an embodiment, the merged pool control system 100a (or more specifically, the unified control module 109) may be configured to receive the raw information from the plurality of described data sources, as shown in step 117.

In an embodiment, the adaptive pool control system 100 may be configured to perform a “Machine Learning & Predictive Analysis” step 112 using the data collected by the unified control module 109. In an embodiment, this machine learning and predictive analysis may be performed by the unified control module 109. In said embodiment, the unified control module 109 may comprise an artificial intelligence (“AI”) system, AI bot, or other AI component specifically configured to carry out the learning/prediction functions of step 112. In said embodiment, this AI component is integral to the control logic and decision-making processes within step 112.

In an embodiment, the unified control module 109, the EPCS module 110 and the IAPCEMS module 111 operate in an integrated manner to process external sensor inputs, environmental databases, and system status indicators, and provide the necessary foundation for predictive thermal and operational modeling executed in step 112. In an embodiment, the input to the machine learning and predictive analysis step 112 may be derived from the collective data acquisition and processing performed by the unified control module 109, the EPCS module 110, and the IAPCEMS module 111.

In an embodiment, predictive thermal solar gain information 113a and predictive direct solar gain information 113b may be generated by the adaptive unified control module 109 of the pool control system 100 from the Machine Learning & Predictive Analysis step 112. The predictive thermal solar gain 113a and predictive direct solar gain 113b may be generated within the adaptive pool control system 100 using internal algorithms, predictive modeling, and optionally machine learning techniques. These predictions are based on analysis of environmental data received from the data sources, such as temperature sensors, time-of-day schedules, historical and real-time weather databases, and solar irradiance factors. The adaptive pool control system 100 uses this generated information to optimize heater operation and reduce energy consumption. In an embodiment, the “Machine Learning & Predictive Analysis” step 112 may be performed by an AI component of one of the modules. For example, in said embodiment, the unified control module 109 may comprise an AI component, AI system, or a different AI-based element, which is configured to perform the machine learning & predictive analysis step 112 of the overall adaptive pool control system. As is understood, the machine learning and predictive analysis step 112 is configured to process data collected and pre-analyzed by the unified control module 109, EPCS module 110, and IAPCEMS module 111, in order to determine key operational parameters of the system. These determinations allow the adaptive pool control system 100 to deliver proactive, energy-efficient, and schedule-optimized pool heating and circulation control. Based upon the performed Machine Learning & Predictive Analysis step 112, the adaptive pool control system 100 may be configured to make to various conclusions regarding how to proceed with maintaining the pool at the set point temperature.

In an embodiment, from the machine learning and predictive analysis step 112, the adaptive pool control system 100 may be configured to perform steps comprising determining a thermal solar start/stop time 115, determining a most efficient heater and its corresponding start/stop time 116, and determining desired pump speed 119. In an embodiment, the IAPCEMS module 111 may be configured to perform steps 115, 116 and 119. The adaptive pool control system 100 may further be configured to initiate a “rainy day shutdown” 114 or similar operational shutdown conditions, during which the system discontinues efforts to maintain the minimum set point temperature of the pool. Such shutdowns may be triggered based on environmental conditions, including but not limited to rainfall, forecasted inclement weather, or other indicators of anticipated non-use, thereby conserving energy when heating is unnecessary. In an embodiment, the rainy-day shutdown step 114 may be performed/initiated by the unified control module 109. In an alternative embodiment, the rainy-day shutdown step 114 may be performed/initiated by the IAPCEMS module 111.

In an embodiment, after determining a thermal solar start/stop time 115, the adaptive pool control system may be configured to send a corresponding signal to a thermal solar heating system 120. In an embodiment, the thermal solar heating system 120 may be configured to selectively provide heating the pool using energy collected from the sun. In an embodiment, after determining a heater start/stop time and determining which heater (of the available heaters for the pool) is the most efficient for the current heating scenario (step 116), the adaptive pool control system 100 may be configured to send a signal to a corresponding natural gas heat 121, electric heat pump heater 122 and/or a gas-fired heat pump heater 123 to provide the necessary heating to the associated pool 101. In an embodiment, after utilizing information on current temperatures (real-time temperature data collected from the pool temperature sensors 102, outdoor air temperature sensors 103 and heater outlet temperature sensors 104), current pool usage, and time of day, the adaptive pool control system 100 may be configured to send a corresponding signal to a variable speed pool pump 124 in order to adjust the pump speed to further aid in maintaining the temperature above the minimum set point temperature. In an embodiment, the EPCS module may be configured perform the steps of actuating the heaters and pump (e.g., steps 120, 121, 122, 123 and 124). In an embodiment, the rainy day shutdown operation 114 may be configured to send a signal to the thermal solar heating system 120, natural gas heater 121, electric heat pump heater 122, gas-fired heat pump heater 123 and the variable speed pool pump 124 to either cease operation, or otherwise assume operating conditions consistent with those established for an unoccupied pool.

As is understood, the thermal solar heating system 120, natural gas heater 121, electric heat pump heater 122, gas-fired heat pump heater 123 and the variable speed pool pump 124 may each be in suitable communication with the pool 101, such that the each of these devices may influence pool conditions in accordance with the corresponding signal received from the adaptive pool control system 100 and their corresponding function (e.g., a heater will be configured to provide heating to the pool and a variable speed pump will be configured to pump and circulate the water in the pool). For example, the electric heat pump heater 122 may be configured to be turned on when the adaptive pool control system 100 determines that the pool 101 is too cold during operating hours (e.g., below set point temperature). As these devices 120-124 manipulate the temperature and flow of water within the pool 101, the resultant changes in temperature will influence the information collected or identified by the pool temperature sensors 102, the heater outlet temperature sensors 104 and the gas valve relay 105a. This in turn creates a repeating cycle, wherein information collected by the sensors 102, 103, 104, relay 105a and the current transformer switch 105b are again received by the adaptive pool control system 100, along with the information from the open and close time and NOAA weather databases 107, 108, to be used to assess the heating needs of the pool 101 and manipulate the corresponding devices 120-124, accordingly.

The adaptive pool Control System 100 is designed to reduce the consumption of natural gas (NG), or fuel/energy from other power sources, which is used to heat a swimming pool. The specially designed software and onsite pool control with imbedded firmware of the adaptive pool control system 100 may be configured to save energy by turning the corresponding pool heater off at or before the scheduled Pool-Close-Time and turning the heater on to heat the pool to the set-point temperature by the Pool-Open-Time. The set-point temperature that the pool is heated to by Pool-Open Time may change depending on the predicted solar heat gain (e.g., the predicted amount of heating provided to the pool by the sun). By maintaining the pool at a lower temperature while it is not in use, the total amount of heat loss may be reduced. Furthermore, by only heating the pool at the appropriate time to reach the set point temperature by pool opening time, heat loss that occurs while the pool is not in use may be significantly reduced. As is understood, heat loss from the pool 101 to the environment is proportional to the temperature differential between the pool water and the surrounding air. By maintaining a lower water temperature during periods of non-use, this temperature differential is reduced, which lowers the rate of heat loss to the environment. Consequently, when the pool is reheated later before opening, the total energy required to reach the set point temperature is reduced compared to maintaining a higher temperature continuously. In an embodiment, this process may be configured to reduce the NG consumption of a NG pool heater by an average of 7.9 therms per day.

The solar heat gain will reduce the amount of heating required to reach the set point temperature, thus taking advantage of the heat provided by the sun and not overheating the pool. In other words, by reducing or temporarily modifying the set-point temperature or active heating schedule, the adaptive pool control system 100 is configured to strategically limit heater operation prior to reaching the final desired water temperature/set point temperature. This control decision is based on a prediction that solar heat gain from either passive or via a thermal solar heat system 120 (or both) will be sufficient to bridge the gap between the current temperature and the desired temperature and thus achieve the final desired temperature for the pool water. This method allows the system to minimize fuel/electrical energy consumption while still meeting user comfort and operational goals through accounting for environmental energy contributions. As described hereinabove, the adaptive pool control system 100 may also be configured to leave the heater off during predicted days of rain if the pool will not be used during days of rain.

In an embodiment, the adaptive pool control system 100 may utilize a combination of hardware and software in order to provide the required control of pool temperatures to provide energy savings. In an embodiment, the software for the adaptive pool control system 100 is designed to minimize heat loss, maintain the water temperature at the lowest point possible more precisely, and use the sun to top off the pool temperature to reach the desired set point temperature, rather than overheating the pool by not accounting for solar heat gain.

The adaptive pool control system 100 may be made accessible to a user through a corresponding application, wherein said application may be downloaded to a mobile device, computer, or other suitable electronic device. This adaptive pool control system application and its associated database(s) may be password protected in order to avoid external tampering with the temperature controls. This application may provide users with access to measurement and verification (“M&V”), savings, alarm reports, and graphs of the collected and generated data.

It should be understood that the software for the adaptive pool control system 100 allows for remote temperature monitoring and control through a suitable device having the corresponding adaptive pool control system application, wherein said software implements a temperature control strategy for suitable temperature control of the water in the associated pool. By implementing this temperature control strategy, the heating of the pool may be optimized to ensure that it is not excessively heated, which would waste energy and money. The adaptive pool control system may be configured to constantly monitor the pool and OSA temperature, as well as inputs from other devices, sensors, databases, etc., that may be pertinent to effectively controlling the pool's temperature, as described herein.

In an embodiment, the corresponding controller (e.g., the unified control module, 109) is a powerful web-enabled industrial I/O device with advanced logic and modular expansion capabilities with specially designed firmware to enable the required temperature control functionalities described herein. The controller may be configured to have built in connector terminals that provide communication with 1-Wire sensors to monitor temperature, solar radiation, humidity, built in relays, connections for digital inputs, thermocouples, and analog inputs.

In an embodiment, the disclosed adaptive pool control system 100 may be configured to provide energy savings by calculating and utilizing adaptive heater start time and end times. The adaptive pool control system 100 may be configured to utilize the known information regarding the pool, such as pool volume, in order to determine how much energy is required to heat the pool to reach the desired set point temperature for the pool at the start of the day. As such, by also knowing the heating capacity of the pool's heater, the adaptive pool control system 100 may be configured to determine when it needs to start heating the pool to reach the set point temperature by the time that the pool opens, and power on the heater at the appropriate time accordingly. In this way, the pool may be provided with only the minimum amount of heating required to achieve the desired set point temperature by the pool's opening time and maintain said temperature during operating hours, as applicable, thus avoiding losing significant amounts of heat beyond the standard operating hours of the pool.

In a similar manner to adaptive heater start time, the adaptive pool control system 100 may calculate and utilize an adaptive heater end time to avoid wasting energy. In an embodiment, this adaptive heater end time may be determined by the adaptive pool control system 100 based upon its prediction of when the pool heater may be turned off to have the pool temperature drop by one degree Fahrenheit below the set point temperature by the pool close time. In an embodiment, through the utilization of the adaptive start and stop times for the heater, the pool heater may be turned on at the appropriate time to reach the desired temperature set point at the pool open time, and turned off such that the temperature of the pool drops one degree Fahrenheit below the set point by the pool close time, with heating being provided during the day as needed to maintain the pool at the set point temperature. As will be discussed in greater detail hereinbelow, the adaptive pool control system may utilize corresponding equations in order to calculate heat loss, solar heat gain, and other relevant values.

As described hereinabove, the adaptive pool control system may be configured to account for supplemental pool heating provided from the sun, described as “solar heat gain.” In an embodiment, the adaptive pool control system 100 may be configured to utilize a pyranometer to measure solar radiation, time of year with latitude and longitude to measure the angle of the sun, surface reflectivity, solar irradiance, and the heat transfer coefficient of water in order to calculate solar heat gain in watts, and then convert the solar heat gain into a corresponding temperature heat gain for the pool water. In an embodiment, the adaptive pool control system 100 may utilize the following equation Eq. 1 to calculate solar heat gain:

Q=A*F*G*U Eq. 1
where:
Q=the solar heat gain in watts
A=the surface area of the water in square meters
F=the solar heat gain factor, which considers the angle of the sun, the amount of solar radiation, and the surface reflectivity
G=the solar irradiance in watts per square meters
U=the heat transfer coefficient of the water

In an embodiment, the calculation of solar heat gain from Eq. 1 can be adjusted by accounting for the number of days in a corresponding month having clear skies, partly cloudy skies, etc. The adaptive pool control system 100 may be configured to compare the predicted solar heat gain calculated from Eq. 1 with the actual solar heat gain determined by measuring the change in pool water temperature over a known time interval during periods of solar exposure, and make adjustments to the solar heat gain equation of Eq. 1 to keep the predicted solar heat gain as close to the actual solar heat gain in the future. The actual solar heat gain provides empirical validation of the predicted value and is used by the system to refine future predictions via machine learning and adaptive calibration.

As described hereinabove, the adaptive pool control system 100 is designed to intelligently manage the heating and pump operation of commercial swimming pools using real-time sensor inputs, predictive analytics, machine learning, and external environmental data. The system balances energy efficiency with user comfort by dynamically adjusting heat input and pump flow to minimize energy consumption while maintaining the target water temperature (e.g., the set point temperature). As described hereinabove, in an embodiment, sensor inputs (including pool temperature, outdoor air temperature, and heater outlet temperature) may be fed into the UCM 109 of the merged pool control system 100a, wherein the UCM performs predictive analysis and regulatory checks. The UCM 109 may transmit control outputs to both the EPCS module 110 and the IAPCEMS module 111. The EPCS module may be configured to execute immediate temperature control logic, whereas the IAPCEMS module 111 may be configured to apply adaptive energy optimization across heating sources and pump speeds. Output signals produced by the merged pool control system 100a may be sent to control the NG heater, electric heat pump, solar thermal system, and variable-speed pool pump. This modular control structure of the adaptive pool control system 100 is described in greater detail below.

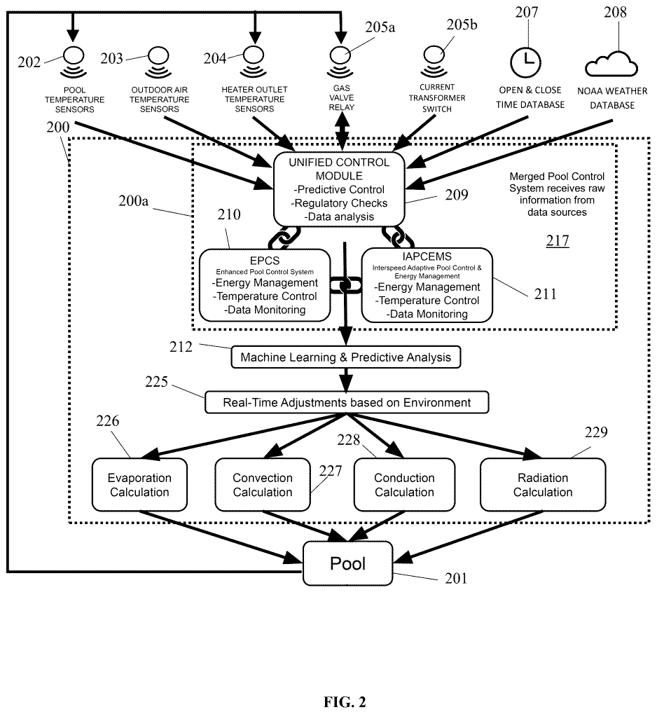

FIG. 2 illustrates a system-level data and control flow diagram of a second embodiment of the adaptive pool control and energy management system 200, according to an aspect. As described hereinabove, the adaptive pool control system 200 may be configured to be in communication with a plurality of sensors, switches, relays, and databases (the hereinabove described data sources) to allow it to collect the information needed to determine the heating needs of a pool 201 at any given moment. Again, in an embodiment, the adaptive pool control system 200 may be in communication with a plurality of data sources 202-208, including pool temperature sensors 202, outdoor air temperature sensors 203, heater outlet temperature sensor 204, a gas valve relay 205a, a current transformer switch 205b, an open & close time database 207 and a NOAA weather database 208. The information received from these data sources may be received by the unified control module 209 of the adaptive pool control system 200, wherein the unified control module 209 is in data communication with the EPCS module 210 and the IAPCEMS module 211, as described hereinabove in FIG. 1. In an embodiment, the unified control module 209 may be configured for predictive controlling and performing regulatory checks and data analysis on the incoming data/information. As described above, the EPCS module 210 and the IAPCEMS module 211 may be in data communication with each other, and be configured to facilitate energy management, temperature control, and data monitoring.

After the information from the data sources 202-208 is received in step 217 and processed by the unified control module 209, the EPCS module 210 and the IAPCEMS module 211 (e.g., the information is received and processed by the merged pool control system 200a), the adaptive pool control system 200 may be configured to further process the received information using machine learning and predictive analysis 212. This machine learning and predictive analysis 212 may be followed by calculating real-time adjustments to be made to pool elements (such as the heater(s) and pump(s)) based upon the environment 225, wherein the real-time adjustments are determined based on several calculations. In an embodiment, the real time adjustments based on environment step 225 may be performed through the coordinated effort of the EPCS module 210 and IAPCEMS module 211, wherein the EPCS module 210 is configured to deliver the corresponding controls to the corresponding pool element (e.g., the heater(s), pump(s)). In an embodiment, these calculations may include heat loss calculations, including an evaporation calculation 226, a convection calculation 227, a conduction/transmission calculation (e.g., heat lost from the pool to the surrounding environment) 228 and a radiation calculation 229, which correspond to the four different areas of heat loss which make up the total heat loss in a pool. In an embodiment, these calculations 226-229 may be performed by the unified control module 209.

Evaporation rate is a function of pool water temperature, relative humidity, and outside air temperature. For every gallon of water lost through evaporation, approximately 8,000 BTU is removed from the pool with the water vapor. In an embodiment, evaporation heat loss may account for approximately 66.7% of the total heat loss from a pool, whereas convection heat loss may account for about 16.7%, radiant heat loss for about 11.1%, and transmission heat loss for approximately 5.6%. As such, the calculation of evaporation heat loss may serve as a base for estimating the other modes of heat loss, particularly in systems where direct measurement of all loss types is impractical.

Per the 2007 ASHRAE Handbook-HVAC Application, the equation used to calculate pool evaporation heat loss is defined in Eq. 2:

q2=U*A(tₚ—tₐ) Eq. 2
where:
q2=heat loss from pool surface, Btu/h
U=surface heat transfer coefficient
A=pool surface area, ft²
tₚ=pool temperature, ° F.
tₐ=ambient temperature, ° F.

With regards to convection heat loss, heat is transferred to the air by the movement caused within the pool by the tendency of the warmer and therefore less dense water to rise, and colder, denser water to sink, under the influence of gravity, which consequently results in transfer of heat through convection. Radiant heat transfer is a function of pool temperature and cloud cover. The warm water loses heat as it gives off infrared radiation back to the sky, especially at night. Cloud cover will reduce this radiant heat loss effect, but the atmosphere will still absorb and scatter this thermal energy like light waves. Transmission heat loss accounts for heat that is lost through the walls of the pool directly to the ground or other surfaces in contact with the pool. Again, from the understanding that each type of heat loss contributes to a rough percentage of the overall heat loss, the evaporation heat loss calculation of Eq. 2 may be utilized to estimate the corresponding convection, conduction, and radiation heat losses.

Upon completing these heat loss calculations 226-229 and determining the required heating to provide to the pool 201 to reach and/or maintain the set point temperature, energy/fuel may be provided to the necessary heaters, pumps, and other pool control elements, as described in FIG. 1. As is understood, the resultant heating provided to the pool will be subsequently detected by the applicable sensors that are in communication with the adaptive pool control system 200, including the pool temperature sensors 202, the heater outlet temperature sensors 204 and the gas valve relay 205a. As such, the adaptive pool control system 200 may be configured to receive the updated information from the pool temperature sensors 202, the heater outlet temperature sensors 204 and the gas valve relay 205a, while also receiving updated information from the outdoor air temperature sensors 203, the current transformer switch 205b, the open & close time database 207 and the NOAA weather database 208. This updated information may be used to repeat the temperature control process outlined hereinabove. This mechanism of actively monitoring information from a plurality of different sources may allow the adaptive pool control system 200 to accurately determine when the associated pool 201 will require heating, as well as the amount of heating required, thus minimizing the amount fuel or energy needed to heat the pool 201 by not overheating said pool 201 or providing heating when it is unnecessary.

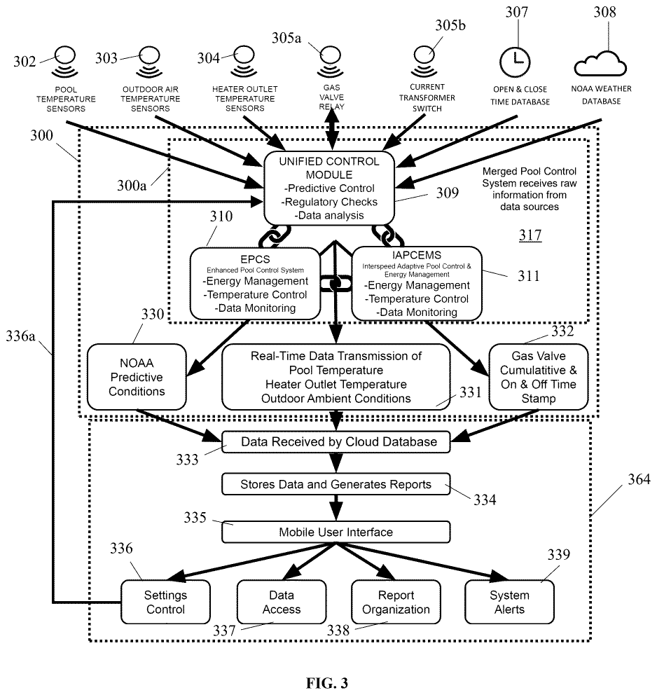

FIG. 3 illustrates a system-level data and control flow diagram of a third embodiment of the adaptive pool control and energy management system 300, according to an aspect. As described hereinabove, the adaptive pool control system 300 may be configured to be in communication with a plurality of sensors, switches, relays, and databases to allow it to collect the information needed to determine the heating needs of a pool 301. Again, the adaptive pool control system 300 may be in communication with pool temperature sensors 302, outdoor air temperature sensors 303, heater outlet temperature sensors 304, a gas valve relay 305a, a current transformer switch 305b, an open & close time database 307 and a NOAA weather database 308. The information received from these data sources may be received by the unified control module 309 of the adaptive pool control system 300 in step 317, wherein the unified control module 309 is in data communication with the EPCS module 310 and the IAPCEMS module 311, as described hereinabove in FIG. 1. In an embodiment, the combination of the Unified Control Module 309, the EPCS Module 310, and the IAPCEMS Module 311 may collectively be referred to as a merged pool control system 300a. This merged pool control system 300a may be configured to receive sensor and database inputs, perform predictive analysis, execute rule-based and adaptive control routines, and coordinate heating and circulation commands to optimize energy efficiency and maintain desired pool conditions.

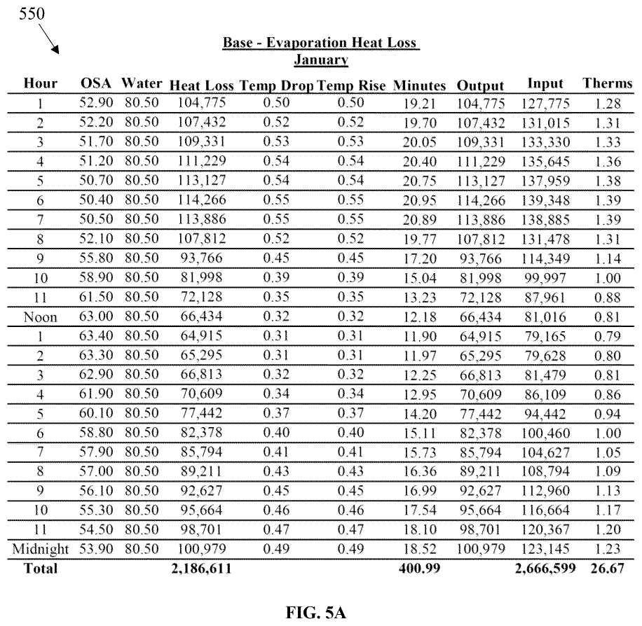

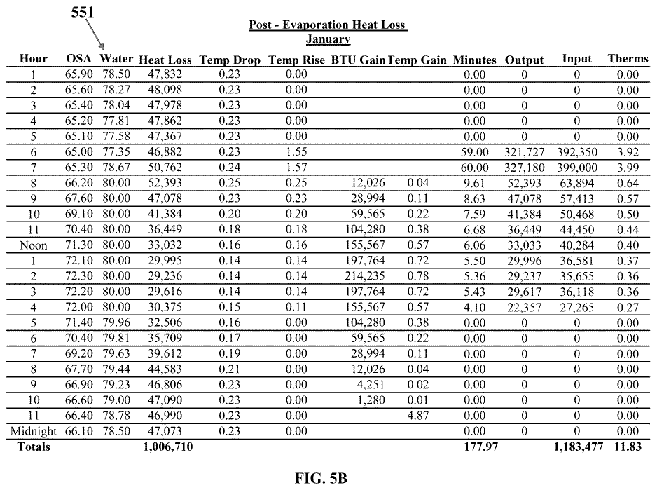

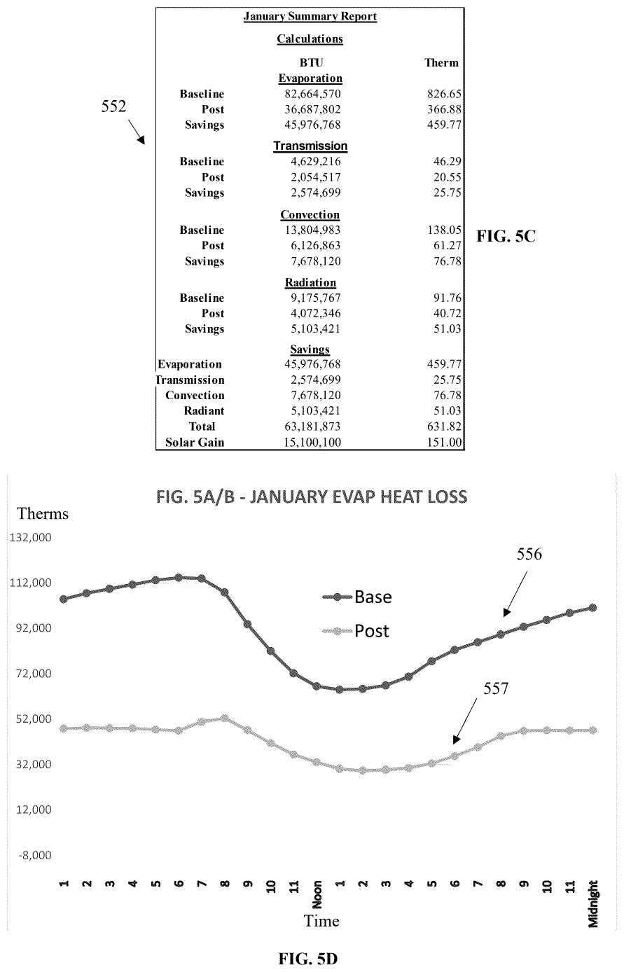

As can be seen in FIG. 3, the merged pool control system 300a may be configured to collect information from the variety of sensors, switches, relays and databases, as “conditions” from these data sources, including NOAA predictive conditions 330, real-time data for the pool temperature, heater outlet temperature and the outdoor ambient conditions (ambient temperature, humidity) 331 and the gas valve cumulative time and on and of time stamp 332. These conditions based upon the information collected from the data sources may be sent to a corresponding cloud database of a could platform 364 by the UCM 309 in step 333, such that said condition information may be securely stored and accessed by the adaptive pool control system 300 as needed. This stored condition information on the cloud database may subsequently be utilized by the cloud platform 364 to generate reports 334 for user review and further data analysis. In an embodiment, these generated reports may contain relevant information pertaining to adaptive pool control system 300 operation, including recorded water temperature, ambient temperature, heat loss, temperature drop, temperature rise, duration of pump operation (in minutes for a respective hour), and heat input and output. In an embodiment, the reports generated may include charts and graphs comparable to those shown in FIGS. 5A-7. In FIG. 3, the arrows leading to elements 330, 331, and 332 from the merged pool control system 300a reflect data collected by the UCM 309. As is understood, this data may be utilized in the coordinated output of the Unified Control Module 309, EPCS Module 310, and IAPCEMS Module 311, with these three modules operating as a unified, joint system. Accordingly, the term “Merged Pool Control System” 300a may be used to describe the combined operation of these three elements when referring to their shared outputs or integrated logic.

In an embodiment, the disclosed adaptive pool control system 300 may be configured to be accessed through a corresponding program or application on a mobile device, or other applicable electronic device (such as a desktop or laptop computer). The collected information and generated reports on the cloud database of the cloud platform 364 may be accessed by a user through a corresponding mobile user interface 335 or other applicable user interface on a corresponding device. Within said user interface 335, a user may be provided with several different options, including settings control 336, data access 337, report organization 338 and system alerts 339.

The settings control 336 option may provide a user with various options to adjust system settings and other user-defined parameters that influence the operation of the adaptive pool control system 300. In an embodiment, the settings that a user may access and control through the settings control 336 options may include: the set point temperature for the pool, open/close scheduling times, thresholds for initiating shutdown operations, pump speed preferences, and other system behavior preferences. These settings allow the user to personalize and fine-tune how the adaptive pool control system 300 responds to environmental conditions and usage patterns, and said settings may directly affect the logic executed by the Unified Control Module 309, EPCS Module 310, and IAPCEMS Module 311. This settings control 336 may be configured to modify the operation of the adaptive pool control system 300 and thus the settings control is shown as being in communication merged pool control system 300a in FIG. 3 through control arrow 336a. The mobile user interface 335 may also provide the user with a data access option 337, wherein the user may access raw and/or processed data collected by the adaptive pool control system 300. Additional options that may be provided to the user through the mobile user interface may include a report organization option 338, that allows the user to modify how reports generated by the adaptive pool control system 300 are organized, and a system alerts option 339, that allows the user to view relevant alerts provided by the adaptive pool control system 300 in relation to the operations of the pool. It should be understood that other options and controls may also be made available on the mobile user interface (or other user interfaces) for the adaptive pool control system 300, in order to facilitate user control of the adaptive pool control system 300 and monitoring of the past and present conditions of the associated pool in communication with the pool control system 300.

As is understood, the disclosed adaptive pool control system 300 may be configured to utilize a control logic flow in order to suitably control the heating of a pool to save energy while still maintaining a suitable pool temperature. In an embodiment, the control logic flow of the adaptive pool control system 300 may utilize startup logic, which initializes all sensor communications, loads 30 days of prior historical data and retrieves the current heating schedule and set-point temperature.

In an embodiment, this control logic flow may further comprise a predictive heating algorithm having five steps, which may be performed sequentially by the merged pool control system 300a of the adaptive pool control system 300. In an embodiment, the following steps of the predictive heating algorithm may be performed sequentially as described below, but in an alternative embodiment, these steps may also be modified and/or reordered, as necessary. Step 1 of the predictive heating algorithm may be to download the NOAA forecast for the next 24 hours. Step 2 of the predictive heating algorithm may be to estimate the solar heat gain defined in Eq. 3

E_{Absorbed}=I*A*(1−α) Eq. 3
Where:
I=solar irradiance
A=pool surface area
α=albedo of the pool surface (the fraction of light that the pool surface reflects).

Following the solar heat gain calculation from Eq. 3, Step 3 of the predictive algorithm may be to calculate total expected heat loss using Eq. 2. Step 4 of the predictive algorithm may be to determine the required heater run time defined in Eq. 4.

t_{required}=(Heat_Loss−Solar Gain)/Heater_Capacity Eq. 4
where:
t_{required}=the required heating time for a selected heater, in hours
Heat_Loss=heat loss from pool surface,
Solar_Gain=heat absorbed by the pool from solar heating,
Heater_Capacity=the heating capacity for the selected heater

Following the required heater run time calculation from Eq. 4, Step 5 of the predictive algorithm may be to schedule the heater start time based on the required heating time to meet the set point temperature by pool opening time.

In addition to predictive heating algorithm described hereinabove, the control logic flow may further comprise operational logic utilized by the adaptive pool control system 300 during pool operation. Under this operational logic may, every ten minutes the adaptive pool control system 300 may be configured to: update current sensor readings, recalculate heat loss (Eq. 2), solar heat gain (Eq. 3) and adjust the heating schedule if needed, log all data points to a cloud database with timestamps and display key metrics in a user dashboard (temperature, heater runtime, energy savings) for user observation.

As described hereinabove, the adaptive pool control system 300 may be configured to react to rainy days (or predicted rainy days) to provide further energy savings. As such, in an embodiment, the control logic flow may further comprise an optional rainy-day shutdown logic. By this rainy-day shutdown logic, if NOAA indicates a greater than 70% chance of rain during the pool's operation window, heater operation may be suspended by the adaptive pool control system 300, unless overridden by the user. Additionally, in an embodiment, the UCM 309 may initiate a rainy-day shutdown when predicted solar gain falls below a defined threshold for a specified duration. In either case, an alert may be sent to the user notifying them of the suspension, allowing the user to override the shutdown and resume heater operation if desired.

In addition to the control flow logic described hereinabove, the adaptive pool control system 300 may be further configured to utilize pump speed control logic to control the operation of the pump of a pool. In an embodiment, the adaptive pool control system 300 may be configured to decrease pump speed to utilize a default or low pump speed overnight while not in use, and when the heating is turned off. The pump speed may then be increased/ramped up to a medium or high pump speed during heater operation or other heating events (to maximize circulation) and during standard pool open hours (for compliance with turnover requirements). Furthermore, the adaptive pool control system may be configured to adjust pump speed dynamically based on real-time heater output and temperature delta.

In order to provide users with access to collected data and keep users of the adaptive pool control system 300 informed on current relevant matters, the adaptive pool control system may be suitably configured for data logging and user alert functionalities. In an embodiment, all operations of the adaptive pool control system 300 may be logged every ten minutes, with alerts being triggered for: the pool water temperature dropping below a designated minimum temperature, the heater runtime being greater than expected and any loss of communication with the disclosed modules (the unified control module 309, EPCS module 310 and IAPCEMS module 311). In an embodiment, the logged data that is collected and generated by the adaptive pool control system 300 may be stored on a secure cloud server, wherein this logged data may be accessible through a web or mobile application. This web or mobile application may provide a user interface that allows a user to access real-time temperature and system status data, forecasted energy use versus actual energy use, maintenance and compliance alerts, and schedule and set point adjustments.

In an embodiment, the disclosed adaptive pool control system 300 may utilize a learning and optimization engine to process and interpret the received raw data from sensors and other data sources. As disclosed hereinabove, this learning and optimization engine of the adaptive pool control system 300 may utilize machine learning in order to generate the necessary information to suitably control the pool elements to save energy while maintaining suitable pool operating conditions. As described hereinabove, this machine learning may be performed by unified control module 309, wherein the unified control module 309 is configured to continuously compare predicted performance to actual performance, refine the utilized solar gain coefficient and runtime estimates, and optimize heater start and stop times based on pattern recognition. In an embodiment, the unified control module 309 may comprise an AI bot configured to utilize machine learning to calculate the minimum required heating input to maintain the water temperature of the pool at or above a set point temperature. In said embodiment, the unified control module 309 may be configured to calculate predictive thermal solar gain and predictive direct solar gain for use in determining the minimum required heating input to maintain the water temperature of the pool at or above a set point temperature.

Again, as described hereinabove, the adaptive pool control system 300 may comprise three unique, distinct modules configured to be in data communication with each other to facilitate the various functionalities of the adaptive pool control system. As described above, these three modules include the UCM 309, the EPCS module 310 and IAPCEMS module 311. These modules are intentionally separated to modularize system functions, allowing for scalable deployment and independent firmware development. In general, it may be stated that the UCM 309 is configured for data storage, manipulation, and analysis, the EPCS module 310 is configured for delivery of controls to associate pool elements (e.g., heaters and pumps), and the IAPCEMS module 311 is configured for adapting to real time data.

In an embodiment, the unified control module 309 is responsible for collecting, integrating, and analyzing data received from various sources, as described above. In an embodiment, the UCM 309 may function as a central data processor, receive sensor inputs, and determine optimal control actions using predictive and machine learning logic. In an embodiment, the UCM 309 is configured to execute predictive control logic and regulatory checks based on the aggregated data from the various sources. These predictive control operations may include machine learning-based analysis of environmental conditions, historical and forecasted weather data, pool usage schedules, and real-time operational status of heating equipment. Based on this analysis, the unified control module 309 is further configured to determine the optimal heater start and stop times, whether active heating is required or if solar heat gain is sufficient to maintain the desired pool water temperature, the most efficient heater among available heating units, the desired variable pump speeds, and when to execute shutdown operations (e.g., during predicted periods of rain or inactivity). Additionally, the unified control module 309 is configured to issue control commands to components such as pool heaters (natural gas, electric heat pump, or hybrid) and variable speed pool pumps, thereby serving as the decision-making and command issuance layer of the adaptive pool control system 300.

In contrast to the EPCS module 310 and IAPCEMS module 311, which support system operation through enhanced scheduling logic and dynamic energy management, respectively, the unified control module 309 provides centralized system intelligence, orchestrates overall system behavior, and maintains internal regulatory compliance. The UCM 309 also validates system integrity by confirming the operational status of controlled elements via relay and switch feedback mechanisms (e.g., gas valve relay 305a and current transformer switch 305b). In one embodiment, the unified control module 309 is implemented on a web-enabled industrial I/O controller with advanced logic capability and modular expansion support and may include embedded firmware designed specifically for the temperature control strategies disclosed herein.

In an embodiment, the EPCS 310 module performs execution-level temperature control and operational commands derived from the Unified Control Module 309. As described hereinabove, the EPCS module 310 may be configured to execute rule-based control actions, such as heater activation based on scheduled pool use, and provides manual override capabilities (such as a user maintaining pool heater function beyond standard operational hours, per the user's command). In an embodiment, the EPCS module 310 may be further configured to override the IAPCEMS module based on a manual input from a user or maintenance mode activation.

In an embodiment, the IAPCEMS module 311 is configured for adaptive, predictive energy optimization, heater efficiency selection, solar gain estimation, pump speed modulation, and data reporting functions. In said embodiment, the IAPCEMS module 311 applies dynamic energy optimization strategies and adapts system performance based on environmental forecasts and system feedback. In an embodiment, The EPCS module 110 is primarily responsible for fixed-rule scheduling and standard operational control, while the IAPCEMS module 111 provides adaptive control and energy optimization using predictive analytics, environmental feedback, and machine learning. Their coordinated operation under the direction of the unified control module 309 enables a multi-layered control strategy that ensures efficient and intelligent pool heating. It should be understood that the modules 309-311 of the adaptive pool control system 300 are intentionally distinct, separate modules, in order to modularize system functions, allowing for scalable deployment and independent firmware development.

In an embodiment, both the UCM 309 and IAPCEMS modules 311 may be configured to employ machine learning to achieve their described functionality. As described herein, the UCM 309 may serve as the central intelligence for prediction, optimization, and adaptive control, and thus may house the main AI/machine learning systems of the adaptive pool control system 300. In an embodiment, the IAPCEMS module 311 may also have machine learning capabilities independent of those of the UCM 309, and thus the IAPCEMS module 311 may comprise a separate AI system, AI bot, or AI component. The machine learning capabilities of the IAPCEMS module 311 may be specifically designed to provide the localized subsystem control and environmental responses described herein for the IAPCEMS module 311. In short, UCM 309 may be configured to handle global optimization and predictive control, whereas the IAPCEMS module 311 is configured to handle localized adaptation and fine-tuning of specific subsystems.

In an embodiment, a method of controlling heating and circulation of a pool having at least one heater and a pump using an adaptive pool control system is provided, wherein the adaptive pool control system comprises a unified control module (UCM), an enhanced pool control system (EPCS) module in data communication with the UCM, and an Inter-Speed adaptive pool control and energy management system (IAPCEMS) module in data communication with the UCM and the EPCS module. In said embodiment, the method may comprise the steps of: receiving, by the UCM, data from a plurality of data sources, the data comprising pool water temperature, outdoor air temperature, heater outlet temperature, pool usage schedules, and forecasted weather data; calculating, by the UCM, a predicted solar heat gain and a total heat loss for the pool over a control period; determining, a minimum heating requirement to maintain the pool water temperature at or above a predefined set point temperature during a defined pool operation window; activating, by the EPCS module, a scheduled heater operation to maintain the pool water temperature at or above a predefined set point temperature during the defined pool operation window; optimizing, by the IAPCEMS module, the scheduled heater operation based on predicted energy cost, usage patterns, and solar gain potential; and controlling, a speed of the pump based on real-time temperature inputs and energy efficiency models. In an embodiment, controlling a speed of the pump based on real-time temperature inputs and energy efficiency models comprises increasing the speed of the variable speed pump while actively heating the pool. In an embodiment, the data sources may comprise a current transformer switch, wherein data received from the current transformer switch comprises feedback indicating whether electrical current is present at the gas valve, effectively confirming whether an associated gas valve is powered and operating as expected.

In an embodiment, the method of controlling heating and circulation of a pool may comprise the step of turning off, by the EPCS module, the heater of at least one heater before the scheduled pool closing time to allow the pool temperature to taper to approximately one degree Fahrenheit below the set point at closing. The method may further comprise overriding, by the EPCS module, the IAPCEMS module based on manual input or activation of a maintenance mode. In another embodiment, the method may include initiating, by the UCM, a rainy-day shutdown operation when predicted solar gain falls below a defined threshold for a specified period, indicating limited passive heating. The UCM may also send an alert to the user, allowing manual override of the shutdown if desired. The method may further comprise receiving, by the UCM, updated data from a plurality of data sources after controlling pump speed based on real-time temperature inputs and energy efficiency models. The UCM may determine the most efficient heater among the available units for controlling pool heating. In an embodiment, the UCM 309 comprises an Artificial Intelligence (AI) bot configured to use machine learning algorithms to calculate predicted solar heat gain and total pool heat loss over a control period, and to determine the minimum heating requirement necessary to maintain the pool water temperature at or above a predefined set point.

As is understood, the adaptive pool control system 300 is configured to perform certain actions in real-time, including accessing/reading databases and taking sensor readings, temperature inputs, solar irradiance, status feedback, etc., in order to determine the proper actions to take to maintain an associated pool at a desired temperature. In an embodiment, the adaptive pool control system 300, its various modules (UC module, EPCS module and IAPCEMS module), and their associated AI bots may be configured to suitably match data between corresponding databases in real-time in order to achieve the desired goal of maintaining the pool at the desired temperature during pool operating hours. In an embodiment, the adaptive pool control system 300 may be configured to access a historical weather database for data on a particular day the previous year(s) in order to generate a preemptive heating plan for the corresponding day. Additionally, the adaptive pool control system 300 may also react in real-time to measured temperature data, changes in weather (from a real-time weather database), changes in solar irradiance, etc., each of which is stored within a corresponding database, in order to determine the amount of heating necessary to keep the pool at the desired temperature. As such, the adaptive pool control system 300 may be configured to attempt to match the current pool temperature data to the desired pool temperature data by accessing the necessary databases in real-time, assessing what actions need to be taken and performing said actions needed to achieve and maintain the desired temperature (e.g., turning a particular heater or pump on/off), while minimizing power usage. This matching of data between databases in real-time allows the adaptive pool control system 300 to use a combination of preemptive planning and active assessment to minimize heating costs, while maintaining the desired pool temperature during pool operating hours.

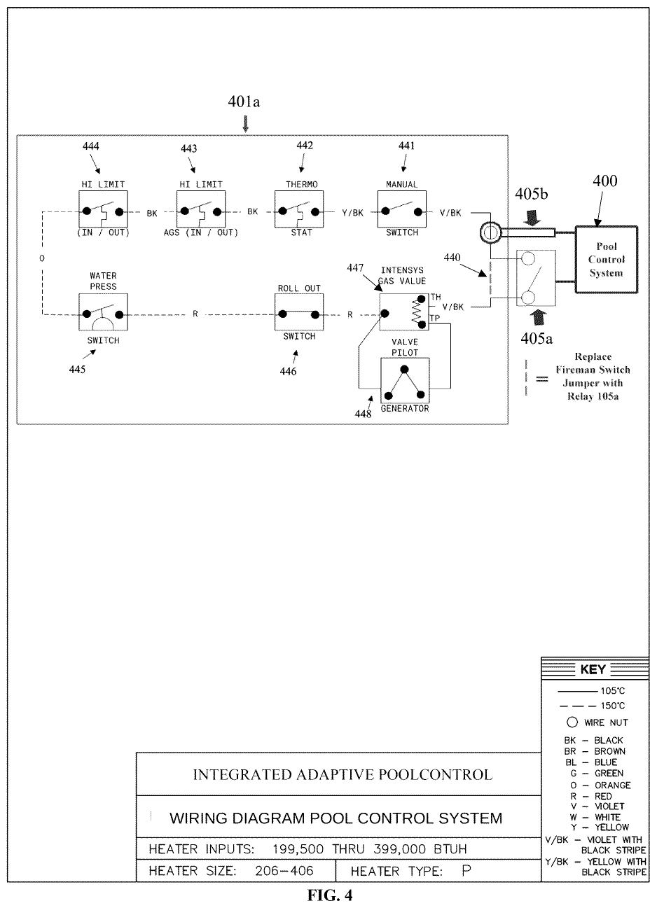

FIG. 4 illustrates an electrical wiring diagram of the adaptive pool control and energy management system 400 engaging with a preexisting pool system 401a, according to an aspect. As is understood, the disclosed adaptive pool control system 400 may be configured for suitable communication with a preexisting pool system 401a in order to facilitate the described functionalities of pool temperature control as disclosed herein. In an embodiment, the preexisting pool system 401a of FIG. 4 may represent the electrical circuit of the preexisting pool.

As seen in FIG. 4, in an embodiment, the preexisting pool system 401a may comprise a manual switch 441, a thermostat element 442 in electrical communication with the manual switch 441, a hi-limit AGS (in/out) 433 in electrical communication with the thermostat element 442, a hi-limit (in/out) 444 in electrical communication with the hi-limit AGS (in/out) 443, a water pressure switch 445 in electrical communication with the hi-limit (in/out) 444, a roll out switch 446 in electrical communication with the water press switch 445, a gas valve 447 in electrical communication with the roll out switch 446 and a pilot generator 448 in electrical communication with the with the gas valve 447. In an embodiment, the gas valve may be any suitable gas valve 447 configured to facilitate the required functionality of the gas valve 447 as disclosed herein, included but not limited to an Invensys gas valve. In an embodiment, the hi-limit AGS (in/out) 433 may correspond to one or more heating devices present in the preexisting pool system 401a, such as the thermal solar heating system 120, the natural gas heater 121, the electric heat pump heater 122, and/or the gas-fired heat pump heater 123 of FIG. 1. In an embodiment, the hi-limit (in/out) 444 may correspond to a pool circulation pump, such as the variable speed pump described hereinabove.

As is understood, the elements of the preexisting pool system 401a are shown in FIG. 4 in their physical wiring context and may receive control signals from the unified control module of the adaptive pool control system 400 (e.g., the unified control module 109 of FIG. 1) via at least one intermediary control component. In an embodiment, this intermediary control component may be a gas valve relay 405a, such as gas valve relay 105a of FIG. 1, wherein the gas valve relay 405a is in electrical communication with the preexisting pool system 401a and the adaptive pool control system 400. In said embodiment, the gas valve relay 405a may be configured to replace an existing fireman switch jumper 440. By replacing the existing fireman switch jumper 440 with the gas valve relay 405a, the gas valve relay 405a may be controlled by the adaptive pool control system 400 to control the heating, pumping and other relevant aspects pool operation.

As seen in FIG. 4, the adaptive pool control system 400 may also be electrical communication with the preexisting pool system 401a through a corresponding current transformer switch 405b. In an embodiment, the current transformer switch 405b may be wrapped around a wire of the circuit of the preexisting pool system 401a, as shown in FIG. 4. The adaptive pool control system 400 may be configured to utilize this current transformer switch 405b as a sensor to determine when current is flowing through the circuit of the preexisting pool system 401a, and thus whether a corresponding heater of the preexisting pool system 401a is currently on or off.

FIG. 5A illustrates a chart 550 showing the evaporation heat loss for a pool running without the adaptive pool control and energy management system for a day in January, according to an aspect. FIG. 5B illustrates a chart 551 showing the evaporation heat loss for a pool running with the adaptive pool control and energy management system for a day in January, according to an aspect. FIG. 5C illustrates a summary report table comparing energy consumption for a pool in January with and without the adaptive pool control and energy management system, according to an aspect. FIG. 5D illustrates a graph comparing hourly evaporation heat loss values for a pool with and without the adaptive pool control system for a day in January, according to an aspect. As described hereinabove, the disclosed adaptive pool control system is configured to allow for improved control of pool temperatures by accounting for various factors, in order to avoid wasting energy heating the pool when it is not necessary to do so.

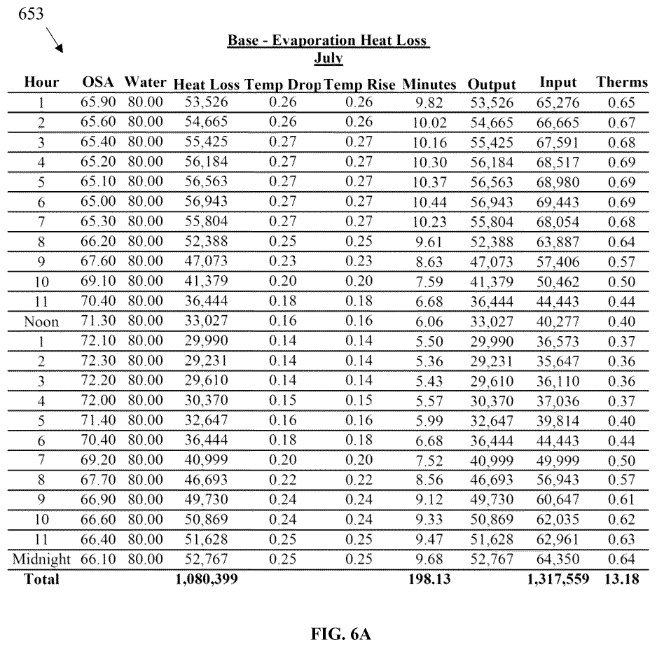

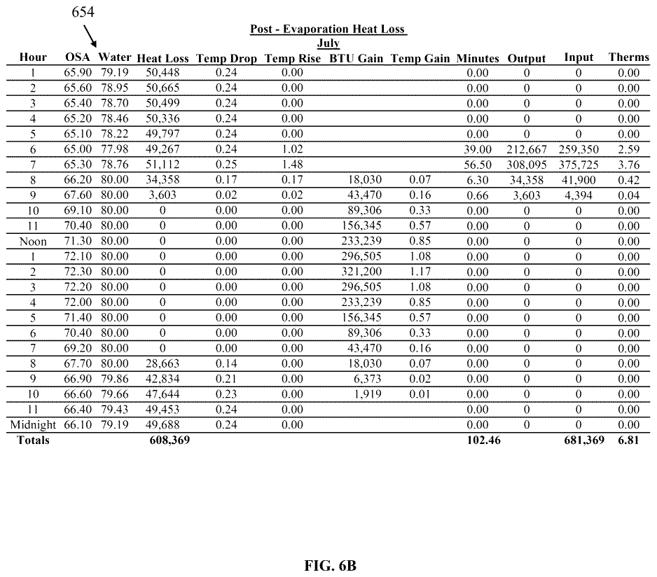

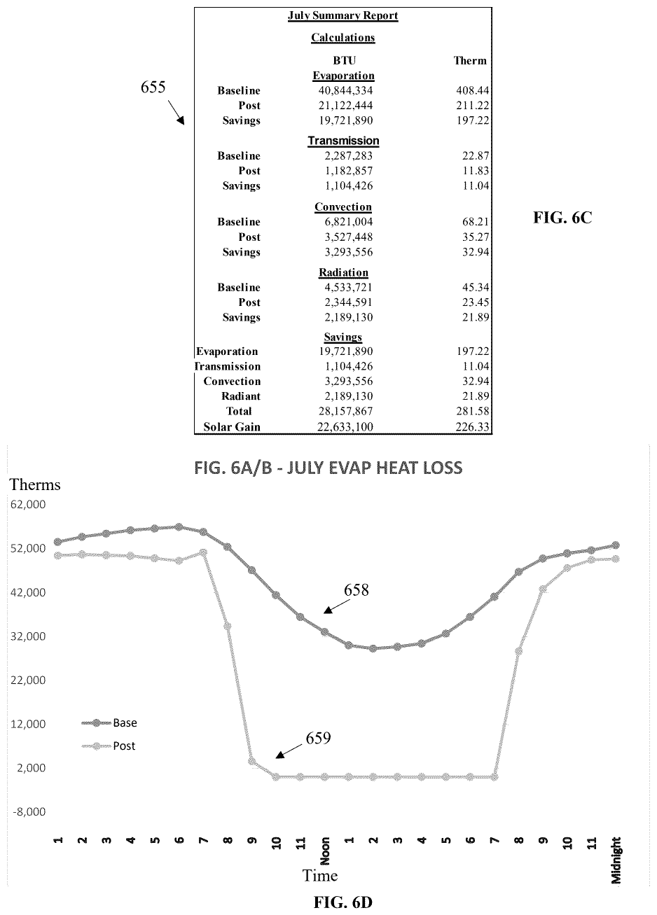

The charts provided herein for FIG. 5A-5C, 6A-6C comprise data collected from a pool in Anaheim CA, having 20′×40′ length and width dimensions with an average depth of 5′, 29,922 gallons (249,711 lbs. of water), with a 399,000 btu input 82% efficiency pool heater. The utilized OSA temperatures are the average for five years from the NOAA database, 2018 to 2022. The standard operating hours (e.g., the operation window) for the pool described in FIG. 5A-5B and FIG. 6A-6B are between 8:00 AM and 10:00 PM. For clarity, chart 550 of FIG. 5A showing the evaporation heat loss for a pool running without the adaptive pool control system may be referred to as a “Base Consumption Chart” 550. In contrast, chart 551 showing the evaporation heat loss for a pool running with the adaptive pool control system may be referred to as a “Post Consumption Chart” 551.

In an embodiment, a matrix may be designed to utilize the above referenced evaporation heat loss equation of Eq. 2, along with set point temperature, and outdoor air temperature, and aggregated additional heat loss components (convection, radiation, and transmission) to determine the total hourly heat loss. This matrix may be utilized internally by the adaptive pool control system to calculate thermal losses and energy requirements on an hourly basis. This matrix is used as the “calculation engine” that produces the data shown in visual form in the Base Consumption Chart 550 of FIG. 5A (as well as the other base and post consumption charts for FIG. 5B, 6A-6B).

By adding the heat losses from convection, radiation and transmission to the heat lost from evaporation, the total heat loss may also be calculated. From this information, the heat outputs, and inputs for every hour of each day may then be calculated. As described, the information from this matrix may be utilized to populate the Base Consumption Chart 550 of FIG. 5A.

Using the same matrix described hereinabove, in conjunction with the actual OSA temperature, the same process of total calculating heat loss, fuel/energy consumption, etc., may be repeated for every hour of each day for a pool having an adaptive pool control system, and compiled into a corresponding Post Consumption Chart, such as Post Consumption Chart 551 of FIG. 5B. By comparing the input totals for the measured day from the Base Consumption Chart 550 of FIG. 5A and the Post Consumption Chart 551 of FIG. 5B, the total energy savings from utilizing the adaptive pool control system over one day may be calculated. This daily energy savings value may also be used to estimate the monthly energy savings that result from the usage of the adaptive pool control, as shown in summary chart 552 of FIG. 5C.

As can be seen in chart 550 of FIG. 5A, the pool lacking the adaptive pool control system provides heating for the pool at all hours of the day, regardless of the presence of pool users or intended operation hours of the pool. In contrast, as seen in chart 551 of FIG. 5B, the pool having the adaptive pool control system provides no heat for the pool during certain times that are not close to the opening/closing time of the pool. In an embodiment, the adaptive pool control system may be configured to provide no heating for the pool between 1:00 AM-6:00 AM and 5:00 PM-12:00 AM, as indicated by 0 values for input/output and therms for the corresponding time spans in chart 551 of FIG. 5B. As can be seen in FIG. 5B, this selective heating of the pool results in the pool remaining within the desired temperature range during operating hours, despite not being constantly heated. Depending on the time that the pool opens and closes, the heating for the pool may be switched on and off at different times. In an embodiment, the heater may be turned on at a specific time to ensure that the required set point temperature is achieved within the pool prior to the pool's opening time and turned off prior to the pool's closing time, to allow the temperature of the pool to drop to a minimum acceptable closing time temperature (which may be about 1 degree Fahrenheit below the usual set point temperature) by the time that the pool closes.

For example, for a pool with a desired water temperature of approximately 80 degrees Fahrenheit, the adaptive pool control system may reduce heater runtime in advance of closing to allow the water temperature to gradually decrease within an acceptable range. As illustrated in FIG. 5B, heater runtime is reduced to approximately 4.10 minutes at 4:00 PM and the heater is subsequently turned off (e.g., between 5:00 PM and 10:00 PM). During this period, the pool temperature is allowed to naturally decline from approximately 80 degrees Fahrenheit to approximately 79 degrees Fahrenheit by the 10:00 PM closing time (with a representative temperature of approximately 79.44 degrees Fahrenheit at 8:00 PM, as shown in FIG. 5B). This controlled temperature reduction maintains acceptable operating conditions while reducing overall energy consumption.

The comparison between daily BTU inputs and therms for the pool lacking the adaptive pool control system, as described for Base Consumption chart 550 of FIG. 5A, and the pool having the adaptive pool control system, as described for Post Consumption chart 551 of FIG. 5B, for January are shown in chart 552 of FIG. 5C. As seen in FIG. 5C, the pool having the adaptive pool control system, as described in chart 551 of FIG. 5B, loses about 45,976,768 fewer BTUs (about 459.77 fewer therms) from heat loss though evaporation in the shown month, when compared to the pool lacking the adaptive pool control system, while still achieving and maintaining the necessary pool temperatures during the pool's standard operating hours (e.g., 8:00 AM-10:00 PM, for the disclosed embodiments of FIG. 5A-6B). When calculated over time, it should be noted that the resultant energy savings from reduced heat loss will become significant, leading to significant savings and reduced waste of power/fuel used for heating the pool.

Chart 552 of FIG. 5C also shows the total heat loss difference for the month of January for the given example pool of FIG. 5A-5B. Over the 31 days of January, the total heat loss savings that results from utilizing the disclosed adaptive pool control system may be about 63,181,873 BTUs (about 631.82 therms), when accounting for evaporation, transmission, convection, and radiant heat loss from the pool. As can be seen in FIG. 5C, the disclosed adaptive pool control system may be configured to provide significant heat savings over time, particularly in colder months, wherein heat loss from a pool is more significant than during warmer months. Furthermore, as shown in the graph of FIG. 5D, in January, the hourly evaporation heat loss for a pool lacking an adaptive pool control system (line 556) is significantly higher than the hourly evaporation heat loss for a pool having an adaptive pool control system (line 557).

FIG. 6A illustrates a chart showing the evaporation heat loss for a pool running without the adaptive pool control and energy management system for a day in July, according to an aspect. FIG. 6B illustrates a chart showing the evaporation heat loss for a pool running with the adaptive pool control and energy management system for a day in July, according to an aspect. FIG. 6C illustrates a summary report table comparing energy consumption for a pool in July with and without the adaptive pool control and energy management system, according to an aspect. FIG. 6D illustrates a graph comparing hourly evaporation heat loss values for a pool with and without the adaptive pool control system for a day in July, according to an aspect. Again, the disclosed adaptive pool control system is configured to allow for improved control of pool temperatures by accounting for various factors, in order to avoid wasting energy heating the pool when heating is not necessary.

As can be seen in chart 653 of FIG. 6A, the pool lacking the adaptive pool control system provides heating to the pool at all hours of the day, regardless of the presence of pool users or intended operation hours of the pool. In contrast, as seen in chart 654 of FIG. 6B, the pool having the adaptive pool control system provides no heat for the pool during certain times that are not close to the opening/closing time of the pool. In an embodiment, the adaptive pool control system may be configured to provide no heating for the pool between 1:00 AM-6:00 AM, and 10:00 AM-12:00 AM, as indicated by 0 values for input/output and therms for the corresponding time spans. Again, depending on the time that the pool opens and closes, the heating to the pool may be switched on and off at different times. In an embodiment, the heater may be turned on at a specific time to ensure that the minimum required temperature is reached prior to the pool's opening time and turned off prior to the pool's closing time, to allow the temperature of the pool to drop to a minimum acceptable pool closing time temperature by the time that the pool closes. Again, in an embodiment, the pool closing time temperature may be 1 degree Fahrenheit below the pool set point temperature. It should also be noted that the heating for the pool may be turned off during pool operating hours if the resultant temperature drop would not result in the pool temperature dropping below the designated set point temperature, as shown for the 10:00 AM time slot in chart 654 of FIG. 6B.

The comparison between daily BTU inputs and therms for the pool lacking the adaptive pool control system, as described for Base Consumption Chart 653 of FIG. 6A and the pool having the adaptive pool control system, as described for Post Consumption Chart 654 of FIG. 6B, for July are shown in chart 655 of FIG. 6C. As seen in FIG. 6C, the pool having the adaptive pool control system, as described in Post Consumption Chart 654 of FIG. 6B, loses about 19,721,890 fewer BTUs (about 197.22 fewer therms) from heat loss though evaporation in the shown month to when compared to the pool lacking the adaptive pool control system, while still achieving the necessary pool temperatures during the pools standard operating hours.

Chart 655 of FIG. 6C shows the total heat loss difference for the month of July for the given example pool of FIG. 6A-6B. Over the 31 days of July, the total heat loss savings that results from utilizing the disclosed adaptive pool control system may be about 28,157,867 BTUs (about 281.58 therms), when accounting for evaporation, transmission, convection, and radiant heat loss from the pool. As can be seen in FIG. 6C, the disclosed adaptive pool control system may be configured to provide notable heat savings over time, even during warmer months. Furthermore, as shown in the graph of FIG. 6D, in July, the hourly evaporation heat loss for a pool lacking an adaptive pool control system (line 658) may also be higher than the hourly evaporation heat loss for a pool having an adaptive pool control system (line 659).

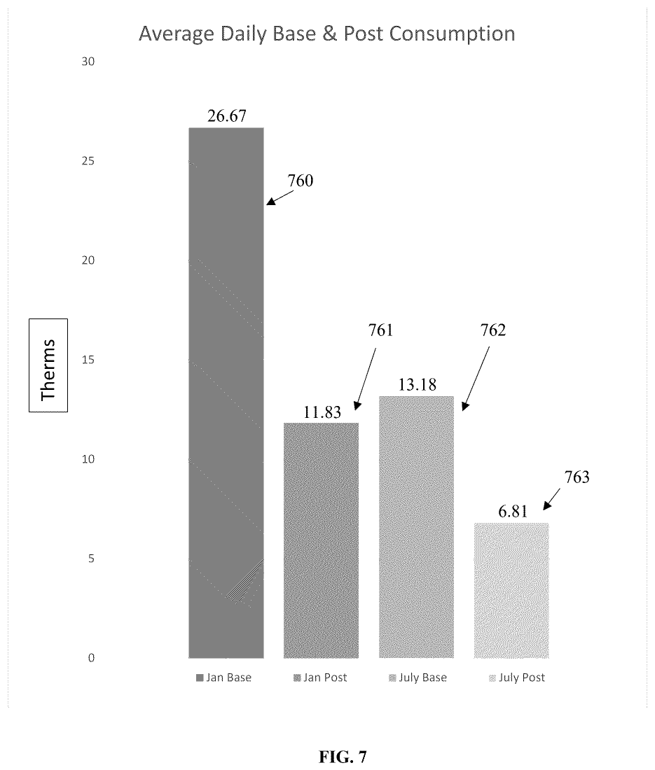

FIG. 7 illustrates a bar graph comparing average daily energy consumptions for heating a pool with and without the adaptive pool control system in January and July, according to an aspect. As described hereinabove, regardless of the month in which a pool is operating, the disclosed adaptive pool control system is configured to provide notable energy savings, thus saving pool owners money, while still maintaining suitable pool temperatures during the pool's operational hours (e.g., when users will be allowed to access the pool). As can be seen in FIG. 7, in an embodiment, the difference between the average daily energy consumption for a pool lacking an adaptive pool control system (bar 760) and the energy consumption for a pool having an adaptive pool control system (bar 761) for the month of January may be about 14.84 therms. Furthermore, in an embodiment, the difference between the energy consumption for a pool lacking an adaptive pool control system (bar 762) and the energy consumption for a pool having an adaptive pool control system (bar 763) for the month of July may be about 6.37 therms.

It should be noted that regardless of the season, the adaptive pool control system is configured to reduce the energy utilized to heat a pool by only providing heating when it is necessary to do so, thus reducing the operating cost for a pool. Furthermore, by accounting for the amount of solar heating received directly from the sun, and potentially an installed thermal solar heating system (e.g., thermal solar heating system 120 of FIG. 1), the adaptive pool control system is configured to avoid overheating the pool, which would result in wasting energy by actively heating the pool, and losing even more energy due to the increased differential between water and ambient temperatures. As described hereinabove, the adaptive pool control system, such as adaptive pool control systems 100, 200, 300 of FIG. 1-3, may utilize machine learning and predictive analysis in conjunction with relevant collected data to build effective models to determine when to heat the pool, which of the available heaters is best to utilize, the most optimal pumps speed and other relevant operation parameters. By receiving all of this data and performing machine learning to determine how to best respond to trends in the received data, significant energy saving may be provided to the pool owner. As a result of the adaptive pool control system being implanted into the pool's existing control system without fundamentally altering said pool's preexisting instrumentation (e.g., the preexisting pool system 401a of FIG. 4 remains largely unchanged after installation of the adaptive pool control system 400), the voiding of warranties may be avoided, thus not influencing a user's ability to receive repairs and other benefits associated with unmodified pool equipment.

It may be advantageous to set forth definitions of certain words and phrases used in this patent document. The term “couple” and its derivatives refer to any direct or indirect communication between two or more elements, whether or not those elements are in physical contact with one another. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Further, as used in this application, “plurality” means two or more. A “set” of items may include one or more of such items. Whether in the written description or the claims, the terms “comprising,” “including,” “carrying,” “having,” “containing,” “involving,” and the like are to be understood to be open-ended, i.e., to mean including but not limited to. Only the transitional phrases “consisting of” and “consisting essentially of,” respectively, are closed or semi-closed transitional phrases with respect to claims.

If present, use of ordinal terms such as “first,” “second,” “third,” etc., in the claims to modify a claim element does not by itself connote any priority, precedence or order of one claim element over another or the temporal order in which acts of a method are performed. These terms are used merely as labels to distinguish one claim element having a certain name from another element having a same name (but for use of the ordinal term) to distinguish the claim elements. As used in this application, “and/or” means that the listed items are alternatives, but the alternatives also include any combination of the listed items.

Throughout this description, the aspects, embodiments or examples shown should be considered as exemplary, rather than limitations on the apparatus or procedures disclosed or claimed. Although some of the examples may involve specific combinations of method acts or system elements, it should be understood that those acts and those elements may be combined in other ways to accomplish the same objectives.

Acts, elements and features discussed only in connection with one aspect, embodiment or example are not intended to be excluded from a similar role(s) in other aspects, embodiments or examples.

Aspects, embodiments or examples of the invention may be described as processes, which are usually depicted using a flowchart, a flow diagram, a structure diagram, or a block diagram. Although a flowchart may depict the operations as a sequential process, many of the operations can be performed in parallel or concurrently. In addition, the order of the operations may be re-arranged. With regard to flowcharts, it should be understood that additional and fewer steps may be taken, and the steps as shown may be combined or further refined to achieve the described methods.

If means-plus-function limitations are recited in the claims, the means are not intended to be limited to the means disclosed in this application for performing the recited function, but are intended to cover in scope any equivalent means, known now or later developed, for performing the recited function.

Claim limitations should be construed as means-plus-function limitations only if the claim recites the term “means” in association with a recited function.

If any presented, the claims directed to a method and/or process should not be limited to the performance of their steps in the order written, and one skilled in the art can readily appreciate that the sequences may be varied and still remain within the spirit and scope of the present invention.

Although aspects, embodiments and/or examples have been illustrated and described herein, someone of ordinary skills in the art will easily detect alternate of the same and/or equivalent variations, which may be capable of achieving the same results, and which may be substituted for the aspects, embodiments and/or examples illustrated and described herein, without departing from the scope of the invention. Therefore, the scope of this application is intended to cover such alternate aspects, embodiments and/or examples. Hence, the scope of the invention is defined by the accompanying claims and their equivalents. Further, each and every claim is incorporated as further disclosure into the specification.

What is claimed is:

1. An adaptive pool control system associated with a pool having at least one heater and at least one pump, the adaptive pool control system having:
a merged pool control system comprising:
a unified control (UC) module configured to communicate with one or more of temperature sensors, a weather database, and a pool usage schedule database and to perform predictive control operations based on received environmental and pool usage data;
an enhanced pool control system (EPCS) module in data communication with the UC module, the EPCS module being configured to perform rule-based and time-scheduled control actions including heater activation and shutdown based on predetermined pool usage schedules; and
an Inter-Speed adaptive pool control and energy management system (IAPCEMS) module in data communication with the UC module and the EPCS module, the IAPCEMS module being configured to perform dynamic energy optimization, including adjusting heater prioritization, and varying pump speed according to predicted thermal load;
wherein the adaptive pool control system is configured to receive data from the one or more of temperature sensors, the weather database, and the pool usage schedule database, calculate a minimum required heating input to maintain a pool water temperature of the pool at or above a set point temperature during a defined pool operation window, determine a most efficient heater of the at least one heater and corresponding start and stop times for the most efficient heater, and operate the most efficient heater and the at least one pump in accordance with the calculated minimum required heating to optimize energy efficiency while maintaining desired pool conditions during the defined pool operation window.

2. The adaptive pool control system of claim 1, wherein the EPCS module is further configured to override the IAPCEMS module based on a manual input from a user or a maintenance mode activation.

3. The adaptive pool control system of claim 1, wherein the UC module is configured to initiate a rainy-day shutdown operation when predicted solar gain is below a threshold for a defined period.

4. The adaptive pool control system of claim 1, wherein the UC module comprises an Artificial Intelligence (AI) bot configured to utilize machine learning to calculate the minimum required heating input to the pool to maintain the water temperature of the pool at or above the set point temperature.

5. The adaptive pool control system of claim 4, wherein the UC module is further configured to calculate predictive thermal solar gain and predictive direct solar gain for use in calculating the minimum required heating input to the pool to maintain the water temperature of the pool at or above the set point temperature.

6. The adaptive pool control system of claim 1, wherein the adaptive pool control system is configured to be associated with the pool without voiding warranties of the at least one heater, the at least one pump, or an associated pre-existing pool control system.

7. A method of controlling heating and circulation of a pool having at least one heater and at least one pump using an adaptive pool control system, the adaptive pool control system comprising a unified control (UC) module, an enhanced pool control system (EPCS) module in data communication with the UC module, and an Inter-Speed adaptive pool control and energy management system (IAPCEMS) module in data communication with the UC module and the EPCS module, the method comprising:
receiving, by the UC module, data from a plurality of data sources, the data comprising one or more of a pool water temperature, outdoor air temperature, heater outlet temperature, pool usage schedules, and forecasted weather data;
calculating, by the UC module, a predicted solar heat gain and a total heat loss for the pool over a control period;
determining, by the UC module, a minimum heating requirement to maintain the pool water temperature at or above a predefined set point temperature during a defined pool operation window;
activating, by the EPCS module, a scheduled heater operation to maintain the pool water temperature at or above the predefined set point temperature during the defined pool operation window;
optimizing, by the IAPCEMS module, the scheduled heater operation based on predicted energy cost, usage patterns, and solar gain potential; and
controlling, by the IAPCEMS module, a speed of the pump based on real-time temperature inputs and energy efficiency models.

8. The method of claim 7, further comprising turning off, by the EPCS module, the at least one heater before a scheduled pool closing time to allow the pool water temperature to taper to approximately one degree Fahrenheit below the predefined set point temperature at the scheduled pool closing time.

9. The method of claim 7, further comprising overriding, by the EPCS module, the IAPCEMS module based on a manual input by a user or a maintenance mode activation.

10. The method of claim 7, further comprising initiating, by the UC module, a rainy-day shutdown operation when predicted solar gain is below a threshold for a defined period, wherein the rainy-day shutdown operation comprises ceasing operation of the at least one heater and the at least one pump.

11. The method of claim 7, wherein the UC module comprises an Artificial Intelligence (AI) bot configured to use machine learning for calculating the predicted solar heat gain and the total heat loss for the pool over a control period and determining the minimum heating requirement to maintain the pool water temperature at or above a predefined set point.

12. The method of claim 7, further comprising receiving, by the UC module, updated data from the plurality of data sources after controlling, by the IAPCEMS module, a speed of the pump based on real-time temperature inputs and energy efficiency models.

13. The method of claim 7, wherein controlling, by the IAPCEMS module, a speed of the pump based on real-time temperature inputs and energy efficiency models comprises increasing the speed of the variable speed pump during heating events.

14. The plurality of data sources of claim 7, further comprising a current transformer switch, wherein data received from the current transformer switch comprises feedback indicating whether electrical current is present at a corresponding gas valve, effectively confirming whether the corresponding gas valve is powered and operating as expected.

15. The method of claim 7, further comprising determining, by the IAPCEMS module, a most efficient heater of the at least one heater.

16. An adaptive pool control system associated with a pool having at least one heater and at least one pump, the adaptive pool control system comprising:
a unified control (UC) module configured to communicate with a plurality of data sources and to perform predictive control operations based on received environmental and pool usage data;
an enhanced pool control system (EPCS) module in data communication with the UC module, the EPCS module being configured to perform rule-based and time-scheduled control actions including heater activation and shutdown based on predetermined pool usage schedules; and
an Inter-Speed adaptive pool control and energy management system (IAPCEMS) module in data communication with the UC module and the EPCS module, the IAPCEMS module being configured to perform dynamic energy optimization, including adjusting heater prioritization, and varying pump speed according to predicted thermal load;
wherein the adaptive pool control system is configured to receive data from the plurality of data sources, calculate a minimum required heating input to maintain a pool water temperature of the pool at or above a set point temperature during a defined pool operation window and operate the heater and pump in accordance with the calculated minimum required heating input to optimize energy efficiency while maintaining desired pool conditions.

17. The plurality of data sources of claim 16 comprising pool temperature sensors, outdoor air temperature sensors, heater outlet temperature sensors, a gas valve relay, a current transformer switch, a pool open and close time database, and a NOAA weather database.

18. The adaptive pool control system of claim 16, wherein the UC module comprises an Artificial Intelligence (AI) bot configured to utilize machine learning to calculate the minimum required heating input to the pool to maintain the water temperature of the pool at or above the set point temperature.

19. The adaptive pool control system of claim 18, wherein the UC module is further configured to calculate predictive thermal solar gain and predictive direct solar gain for use in determining the minimum required heating input to the pool to maintain the water temperature of the pool at or above the set point temperature.

20. The adaptive pool control system of claim 16, wherein the IAPCEMS module comprises an AI bot configured to utilize machine learning to perform the dynamic energy optimization, including adjusting heater prioritization, and varying pump speed according to predicted thermal load.
